(19) United States
(12) Patent Application Publication
(10) Pub. No.: US 2010/0301224 A1
(43) Pub. Date: Dec. 2, 2010

(54) X-ray imaging device having a polychromatic source

(75) Inventors: Christian Morel, Marseille (FR); Franck Debarieux, Marseille (FR); Pierre Delpierre, La Ciotat (FR); Christophe Meessen, Marseille (FR)

Correspondence Address: YOUNG & THOMPSON, 209 Madison Street, Suite 500, Alexandria, VA, 22314, US

(73) Assignee: UNIVERSITE DE LA MEDITERRANEE AIX-MARSEILLE II, MARSEILLE (FR)

(21) Appl. No.: 12/599,441

(22) PCT Filed: May 7, 2008
(86) PCT No.: PCT/FR2008/050807

§ 371 Date: Jan. 22, 2010

(30) Foreign Application Priority Data
May 10, 2007 (FR) 0754974

(51) Int. Cl. G01T 1/24; H05G 1/64

(52) U.S. Cl. 250/370.09

(57) ABSTRACT

An X-ray imaging device includes a polychromatic X-ray source (10) and a detector (1, 2) having pixels suitable for operating in photon counting mode within at least one energy window bounded by at least one adjustable threshold, and at least one counter so that each pixel delivers an output dependent on the number of photons received by the pixel in the energy windows during a predetermined time interval. This device includes adjustment element (12) capable of adjusting, in real time, the thresholds of the pixels in succession in various energy windows, and processing element (16) for carrying out, in real time, differential processing of the outputs of the pixels in the various energy windows.

The present invention relates to an X-ray imaging device having a polychromatic source, and more particularly to such a device comprising a detector having pixels adapted to operate in photon counting mode in an energy window delimited by at least one adjustable threshold, so that each pixel delivers an output dependent on the number of photons received by said pixel in said energy window during a predetermined time interval, and adjustment means capable of adjusting the thresholds of said pixels.

Such detectors are described in the documents “XPAD: A photons counting pixel detector for material sciences and small animal imaging”, P. Delpierre et al., Nucl. Instr. Meth. in Physics Research A 572 (2007) 250-253; “XPAD3: A new photon counting chip for X-ray CT-scanner”, P. Pangaud et al., Nucl. Instr. Meth. in Physics Research A 571 (2007) 321-324; “PIXSCAN: Pixel detector CT-scanner for small animal imaging”, P. Delpierre et al., Nucl. Instr. Meth. in Physics Research A 571 (2007) 425-428.

It is often necessary to know the chemical composition of a material or to locate the presence of a chemical element in an opaque body using visible light. This is true both for screening unknown objects and for locating the presence of a medical marker (e.g. a contrast agent) in a living being.

To that end it is possible to optimize the emission spectrum of a polychromatic X-ray source in order to maximize the contribution of the wavelengths that are strongly absorbed by the element to be detected (which increases the useful contrast) and limit the contribution of the wavelengths that are absorbed preferentially by the other atoms of the surroundings (with the aim of reducing the contrast induced by the background). In that manner, the regions having a high content of the element of interest stand out against the background.

Within that perspective, pseudo-monochromatic sources have been developed by making use of the intense rearrangement peaks emitted at the energies characteristic of an anti-cathode. Nevertheless, there continues to be a large contribution from the many other wavelengths capable of inducing a polluting contrast which drowns the information sought for a complex object. Moreover, the ideal spectrum depends both on the nature of the atom sought and on the environment in which it is to be detected. In practice, therefore, the user is systematically faced with the difficulty of finding a polychromatic source which generates optimum contrast under all use conditions. Within the particular context of medical imaging, a given source is suitable only for a single type of contrast agent (e.g. iodine but not barium or gadolinium) and for a region of the body of given average density (e.g. the breast or the hand).

In order to reduce the dependency in respect of the chemical environment, one method consists in using two polychromatic sources of different spectra, of which one maximizes the energies that are preferentially absorbed by the contrast agent (i.e. a pseudo-monochromatic source with high photon density in the vicinity of the photoelectric transition K of the contrast agent) and the other does not (ideally a source of uniform spectrum). By forming the ratio of the attenuations obtained from each of the two sources, the regions containing the element that is being sought are made to stand out on the image because they alone have an attenuation that is very different under those two conditions.

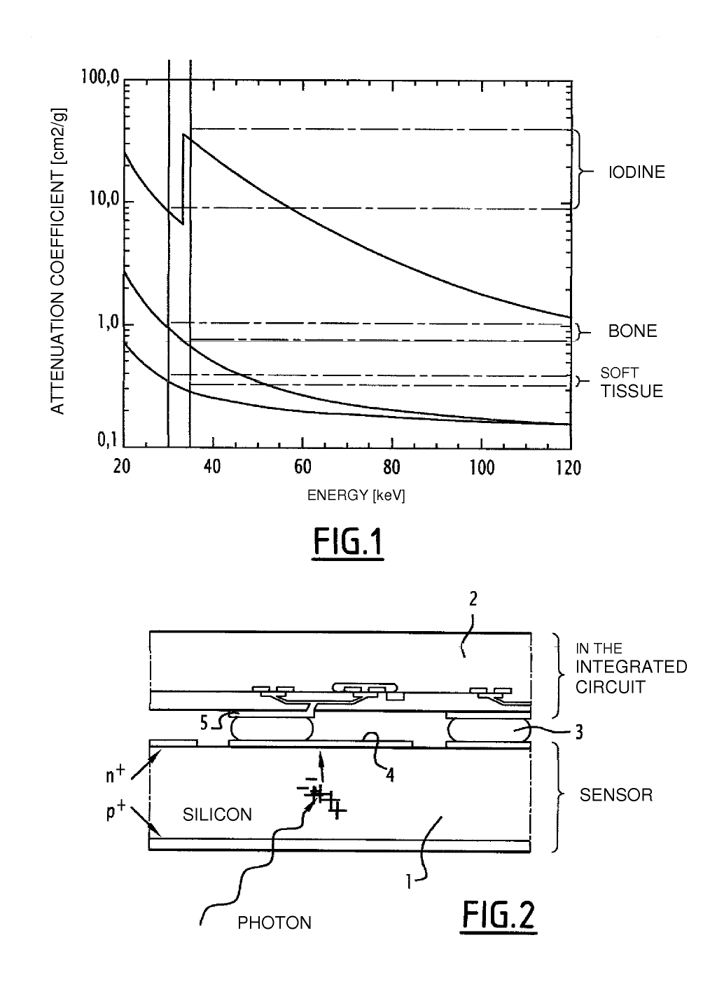

A much more refined solution uses the monochromatic beams available on a synchrotron because they can be assigned to two precise wavelengths, just below and above the transition K of the element that is being sought. The advantage is that absorption by the surroundings scarcely varies at all between the two irradiation conditions, whereas the element of interest exhibits a sudden and very pronounced change in its absorption (change in absorption by a factor of 10 for a pure compound). FIG. 1 shows this method in the case of iodine. In this case, the contrast is no longer polluted by the absorption gradients of the surroundings since it retains virtually constant absorption for the two similar wavelengths. The result is a considerable improvement in the detection sensitivity of the element, as indicated in the literature.

Furthermore, because the beams are monochromatic, it is possible to define an absolute attenuation coefficient for a given energy. The attenuation coefficient is obtained from the ratio of the statistics of incident and detected photons through the object, the logarithm of which is calculated. If two such attenuation coefficients for two given energies are subtracted, a relative attenuation coefficient is obtained, which is proportional to the concentration of the element whose electron transition is situated between those two energies for a given thickness of material. By comparison with a tabulated curve, it is possible to have a quantitative measurement of the concentration of the element starting from the relative attenuation coefficient. In medical imaging, this method allows iodine concentrations as low as 15 to 50 μg/ml to be detected and therefore enables tumours which are invisible by conventional techniques (i.e. with polychromatic sources) to be detected and located.

That technique has therefore been proven, but on the one hand it requires access to a synchrotron beamline and on the other hand it necessitates the sequential acquisition of data, wavelength after wavelength. However, sequential acquisition becomes laborious and long if several chemical elements in the same body are to be detected.

One means of remedying that problem is to work on the “detector” part rather than on the source in order to produce images wavelength by wavelength. Hybrid pixel detectors are particularly dedicated to such a use in so far as they allow the disadvantages associated with the use of synchrotron sources to be overcome.

Document DE 199 04 904 describes the use of single- and double-threshold hybrid pixels for contrast imaging but does not describe a means for obtaining magnification in real time.

Document US 2005/0123093 describes, generally, the principle of contrast magnification.

More particularly, documents US 2006/0056581 and U.S. Pat. No. 6,922,462 describe a method of real-time magnification using a multilayer detector.

However, the electronic circuits associated with each of the detection elements for counting the photons in a given energy window are complicated (several million transistors) and a considerable difficulty is that of containing them within an area that is equal to or smaller than the area of the detection element. Consequently, the inclusion in each of those circuits of a plurality of energy windows, with the corresponding photon counters and adjustment and reading means, results in an increase in the surface area of the pixel and therefore a deterioration in the spatial resolution.

That problem can be remedied in part by using submicron technologies, but the masks and apparatus for producing such circuits become extremely expensive. Even using 0.25 μm technology, it is not possible to reduce the pixel size below 50 μm for only one energy window. That dimension is in practice proportional to the number of windows.

One solution, therefore, would be to make a plurality of energy windows while retaining a simple circuit with a single threshold. That result can be obtained by organizing the pixels into groups of pixels (for example 4 pixels) and assigning a different energy window to each of the pixels in the group (composite pixels). The disadvantage is that the spatial and spectral resolution then corresponds to the size of the group of pixels and is thus impaired.

One means of improving performance is described in the publication Lungren et al., “An area efficient readout architecture for photon counting color imaging”, Nuclear Instruments and Methods in Physics Research, Section A, Accelerators, spectrometers, detectors, Elsevier, Amsterdam NL, Vol. 576, No. 1, 6 Feb. 2007, pages 132-136, XP022072098, ISSN 0168-9002. The method described in that document consists in providing a single energy threshold for each of the pixels but adding two energy windows per group of four pixels. Each pixel is then given an energy weighting calculated by the photon intensity received by each pixel and the number of photons leaving the energy window corresponding to the group of four pixels. Two energy windows are thus obtained, a third window is subtracted from the difference between the total intensity and the sum of the outputs of the first two windows. The spatial resolution in terms of intensity corresponds to the size of one pixel; the energy resolution, on the other hand, corresponds to the size of the group of four pixels, and it is necessary to increase the size of the pixels in order to incorporate the circuit which supplies the two energy windows.

As is described in that article, that method corresponds to an advance over the method in which each of the pixels of a group of four is provided with a different energy window. However, it requires the size of the pixels to be increased, so that the resolution of the energy window corresponds to the size of a group of four pixels, that is to say is worsened by a factor of 4.

The present invention aims to remedy the disadvantages of the prior art.

More particularly, the object of the invention is to provide an imaging device which permits the magnification in real time of a plurality of contrast agents with a single source.

A further object of the invention is to use the same source to find different chemical elements.

To that end, the invention relates to an X-ray imaging device comprising a polychromatic X-ray source (10) and a detector (1, 2) having pixels adapted to operate in photon counting mode in at least one energy window delimited by at least one adjustable threshold, and at least one counter, so that each pixel delivers an output dependent on the number of photons received by said pixel in said energy windows during a predetermined time interval, characterized in that it comprises adjustment means (12) capable of adjusting, in real time, the thresholds of said pixels in succession in different energy windows, and processing means (16) for carrying out, in real time, differential processing of the outputs of said pixels in said different energy windows and in which the adjustment means are arranged to adjust the thresholds of said pixels in real time to different values in an adaptive manner in dependence on a predetermined criterion, the processing means being arranged to process the outputs of said pixels according to a temporal arrangement.

The invention therefore allows a spectral measurement to be carried out in a far greater number of energy windows (limited only by the clock speed of the processors and the power of the source) while being able to retain a simple electronic circuit per pixel, which is advantageous in reducing the size of the pixels and therefore improving the spatial resolution. The spatial resolution is therefore maximized simultaneously in terms of energy and for the selection of energy (resolution corresponding to the size of a pixel).

Another fundamental advantage of the invention is therefore its versatility, since it can be adapted in terms of software to the specific experimental needs of the user.

It will be observed that the above-mentioned detector can especially be two-dimensional. It can in particular be a hybrid pixel detector.

In a particular embodiment, said pixels are elementary pixels grouped into composite pixels according to a predetermined geometric distribution, and the adjustment means are arranged to adjust the thresholds of the different elementary pixels of the composite pixels in different energy windows according to said distribution, the processing means being arranged to carry out spatial processing of the outputs of said pixels of the same adjustment energy.

In an embodiment, the adjustment means are arranged to adjust the thresholds of said pixels in real time to different values according to a cyclic temporal distribution, the processing means being arranged to process the outputs of said pixels according to a temporal arrangement.

In a particular embodiment, at least some of the different energy windows are defined by a bottom threshold and a top threshold.

Also in a particular embodiment, at least some of the different energy windows are contiguous.

In another particular embodiment, the detector is a two-dimensional detector.

In a particular embodiment, the detector is a hybrid pixel detector.

A particular embodiment of the invention will now be described, by way of a non-limiting example, with reference to the accompanying schematic drawings, in which:

FIG. 1 shows the operation of a device of the prior art;

FIG. 2 is a cutaway view, on a very large scale, showing the operation of a photon counting detector;

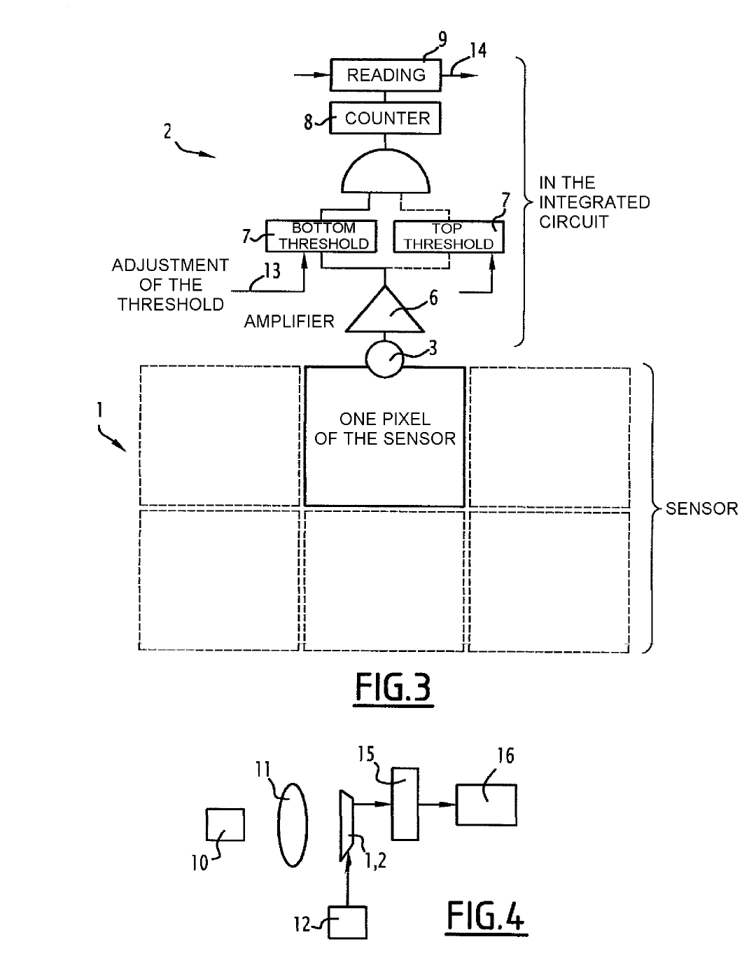

FIG. 3 is a circuit diagram of a pixel of the detector of FIG. 2;

FIG. 4 shows a device according to the invention; and

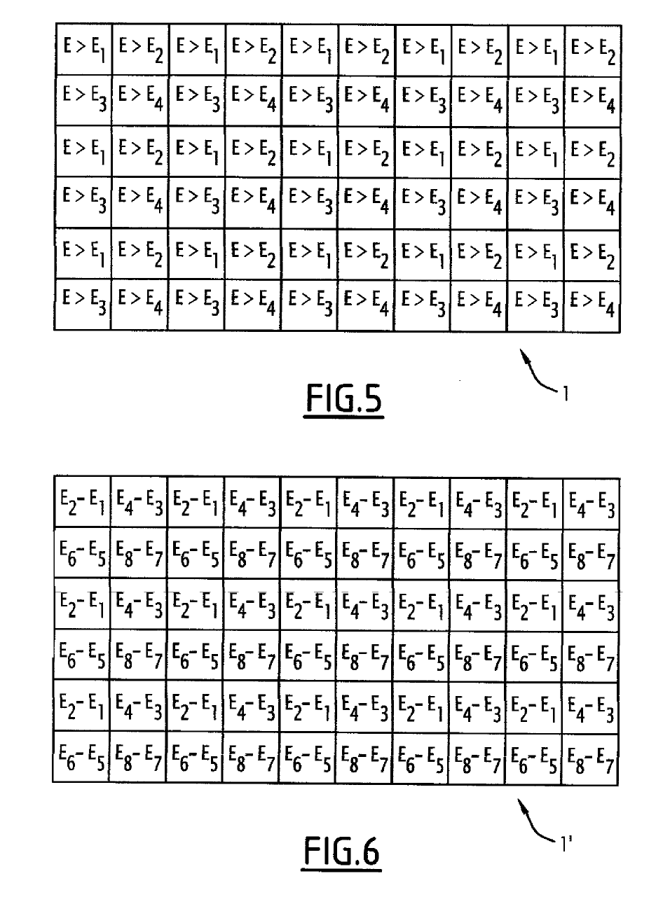

FIGS. 5 and 6 are plan views of two detectors which can be used in a device according to the invention.

Referring to FIG. 2, it will be seen that a photon counting detector of known type is composed of two plates 1, 2 which are connected by soldering points 3. Plate 1 is composed of a semi-conductor (or pure insulator) substrate in which the photons X are converted into electric charges. An electric field is established in the substrate for directing those charges to the electrodes 4 at the surface of the plate 1. Each electrode 4 corresponds to a pixel of the detector. Two possible arrangements for the pixels will be seen with reference to FIGS. 5 and 6.

Each electrode 4 is connected electrically by a soldering point 3 to an electrode 5 of plate 2 (one soldering point per pixel). Plate 2 is a semi-conducting plate comprising as many complete electronic analysis systems as there are pixels. Each electrode 5 is therefore an input electrode of an analysis system.

Referring to FIG. 3, it will be seen that each electronic analysis system is composed of an amplifier 6, single- or double-energy threshold formatting 7 and a counter 8, which is followed by a reading circuit 9.

Referring to FIG. 4, there will be seen a polychromatic X-ray source 10 and a detector 1, 2 such as that just described. The subject for examination 11 is disposed between the source and the detector.

A threshold adjustment device 12, for example a microcomputer, is connected to the threshold adjustment connections 13 of the plate 2.

The reading outputs 14 of the plate 2 are connected to a processor (for example of the FPGA type) 15, the output of which is connected to a processing unit 16, for example the same microcomputer as the device 12.

In the pixelated photon counting detector 1, each of the pixels is associated with an electronic circuit as described above, allowing the photons whose energy is greater than a given value (energy threshold) to be counted. The threshold is adjustable by programming from the microcomputer 12.

The reading system 9 and the threshold adjustment system 7 have an execution speed such that the three operations: threshold adjustment—data acquisition—reading can be carried out in succession in a cyclic or non-cyclic operational manner with virtually no dead time (for example of the order of 2 microseconds) relative to the data acquisition time. This is obtained by a system of rapid transfer to temporary registers located in the plate 2, a predefined matrix of polarization values assigned to the threshold adjustment device 13 and an execution program in the processor 15.

In the case of cyclic adjustment of the thresholds, the example of a tomograph having two energy windows can be taken. The data acquisition sequence is as follows:

### Image 1

adjustment of threshold 1-data acquisition-reading-adjustment of threshold 2-data acquisition-reading-adjustment of threshold 3-data acquisition-reading-adjustment of threshold 4-data acquisition-reading, etc.
a step of rotation of the apparatuses around the subject 11, then

### Image 2

adjustment of threshold 1-data acquisition-reading-adjustment of threshold 2-data acquisition-reading-adjustment of threshold 3-data acquisition-reading-adjustment of threshold 4-data acquisition-reading, etc.
a step of rotation of the apparatuses around the subject 11, then

### Image 3, etc.

These operations take place simultaneously on all the pixels.

There are thus obtained as many energy windows as desired with a single-threshold electronics and while retaining the maximum spatial resolution corresponding to the size of a pixel, both in terms of intensity and in terms of spectral window.

In another mode of implementation, the dynamic adjustment of the thresholds can be carried out in an adaptive manner on the basis of a criterion such as the quality of the contrast of the image. That criterion can be calculated in the processing unit 16, which addresses the new adjustments to be made to the adjustment device 12.

Reference will now be made to FIG. 5.

The principle of composite pixels consists in grouping together a certain number of pixels (2, 3, 4 or more) and assigning a different threshold to each of the elementary pixels or to each of the sub-assemblies (related or convex) of elementary pixels of that composite pixel. In one shot, the apparatus is thus capable of counting the photons starting from different thresholds. By subtracting the counts of the pixels of different thresholds, the number of photons corresponding to an energy window is obtained.

For example, in the case of composite pixels of four elementary pixels, it is possible to obtain, in a single exposure, two different windows: namely En the number of photons counted for an energy greater than Eₙ, and E₁<E₂<E₃<E₄

(E₂−E₁)=[(E<E₂)−(E<E₁)]

and

(E₄−E₃)=[(E<E₄)−(E<E₃)]

In order to select the image elements which correspond to a body which has an absorption jump at energy E₅ such that

E₂<E₅<E₃

the difference of the counts corresponding to those two windows is found:

(E₄−E₃)−(E₂−E₁).

In the case where the two windows are contiguous, the composite pixels can be composed of only three elementary pixels to form two windows:

(E₂−E₁)=[(E<E₂)−(E<E₁)]

and

(E₃−E₂)=[(E<E₃)−(E<E₂)]

They can be arranged in sub-groups as follows:
E₁E₂E₃
E₃E₁E₂

### Or

E₁E₂E₃
E₃E₁E₂
E₂E₃E₁
   and the values measured in the elementary pixels adjusted on the same threshold can be averaged.

In the embodiment of FIG. 6, the number of photons corresponding to an energy window is given directly, for each of the pixels, and two pixels suffice to show the image elements corresponding to a body which has an absorption jump at energy E₅ such that

E₂<E₅<E₃.

A composite pixel of four pixels allows elements corresponding to two different bodies (or contrast products) to be marked, in a single exposure.

1-7. (canceled)

8. X-ray imaging device comprising a polychromatic X-ray source (10) and a detector (1, 2) having pixels adapted to operate in photon counting mode in at least one energy window delimited by at least one adjustable threshold, and at least one counter, so that each pixel delivers an output dependent on the number of photons received by said pixel in said energy windows during a predetermined time interval, characterized in that it comprises adjustment means (12) capable of adjusting, in real time, the thresholds of said pixels in succession in different energy windows, and processing means (16) for carrying out, in real time, differential processing of the outputs of said pixels in said different energy windows and in which the adjustment means are arranged to adjust the thresholds of said pixels, in real time, to different values in an adaptive manner in dependence on a predetermined criterion, the processing means being arranged to process the outputs of said pixels according to a temporal arrangement.

9. Device according to claim 8, in which said pixels are elementary pixels grouped into composite pixels according to a predetermined geometric distribution, and the adjustment means are arranged to adjust the thresholds of the different elementary pixels of the composite pixels in different energy windows according to said distribution, the processing means being arranged to carry out spatial processing of the outputs of said pixels of the same adjustment energy.

10. Device according to claim 8, in which the adjustment means are arranged to adjust the thresholds of said pixels, in real time, to different values according to a cyclic temporal distribution, the processing means being arranged to process the outputs of said pixels according to a temporal arrangement.

11. Device according to claim 8, in which at least some of the different energy windows are defined by a bottom threshold and a top threshold.

12. Device according to claim 8, in which at least some of the different energy windows are contiguous.

13. Device according to claim 8, in which the detector is a two-dimensional detector.

14. Device according to claim 8, in which the detector is a hybrid pixel detector.

15. Device according to claim 9, in which the adjustment means are arranged to adjust the thresholds of said pixels, in real time, to different values according to a cyclic temporal distribution, the processing means being arranged to process the outputs of said pixels according to a temporal arrangement.

16. Device according to claim 9, in which at least some of the different energy windows are defined by a bottom threshold and a top threshold.

17. Device according to claim 10, in which at least some of the different energy windows are defined by a bottom threshold and a top threshold.

18. Device according to claim 9, in which at least some of the different energy windows are contiguous.

19. Device according to claim 10, in which at least some of the different energy windows are contiguous.

20. Device according to claim 11, in which at least some of the different energy windows are contiguous.

21. Device according to claim 9, in which the detector is a two-dimensional detector.

22. Device according to claim 10, in which the detector is a two-dimensional detector.

23. Device according to claim 11, in which the detector is a two-dimensional detector.

24. Device according to claim 12, in which the detector is a two-dimensional detector.

25. Device according to claim 9, in which the detector is a hybrid pixel detector.

26. Device according to claim 10, in which the detector is a hybrid pixel detector.

27. Device according to claim 11, in which the detector is a hybrid pixel detector.
